(19) United States
(12) Patent Application Publication
(10) Pub. No.: US 2023/0151586 A1
(43) Pub. Date: May 18, 2023

(54) WORK TOOL CAMERA SYSTEM FOR UTILITY VEHICLES

(71) Applicant: Deere & Company, Moline, IL (US)

(72) Inventors: Leonardo M. Messias, Dubuque, IA (US); Craig Christofferson, Dubuque, IA (US)

(21) Appl. No.: 17/455,511

(22) Filed: Nov. 18, 2021

(51) Int. Cl. E02F 9/26; B60R 11/04; G06T 5/50; E02F 3/84

(52) U.S. Cl. CPC E02F 9/261; B60R 11/04; E02F 3/847; G06T 5/50; B60R 2300/105; B60R 2300/303; B60R 2300/305; B60R 2300/307; G06T 2207/20221; G06T 2207/30188; G06T 2207/30252

(57) ABSTRACT

In accordance with an example embodiment, a main frame, a work tool configured to move relative to the main frame to move a material, a first imaging apparatus aimed at a first portion of the work tool to capture a first image, a second imaging apparatus aimed at a second portion of the work tool to capture a second image, an electronic processor in communication with the first imaging apparatus and the second imaging apparatus, wherein the electronic processor is configured to generate a modified image, and a display for displaying the modified image of the material being moved by the work tool, wherein the modified image is based on a combination of the first image and the second image, and the modified image omits the work tool.

### TECHNICAL FIELD

The present disclosure generally relates to a utility vehicle. An embodiment of the present disclosure relates to work tool camera system for utility vehicles.

### BACKGROUND

Utility vehicles, such as motor graders, bulldozers, crawlers, feller bunchers, scrapers, excavators, skid and track loaders often use a blade to move material. While operating the utility vehicle, the position of the operator with respect to the work tool can make it difficult to see the amount of material being moved by the work tool at any given time. This is especially true during grading operations or other precision maneuvers.

### SUMMARY

Various aspects of examples of the present disclosure are set out in the claims.

According to a first aspect of the present disclosure, a main frame, a work tool configured to move relative to the main frame to move a material, a first imaging apparatus aimed at a first portion of the work tool to capture a first image, a second imaging apparatus aimed at a second portion of the work tool to capture a second image, an electronic processor in communication with the first imaging apparatus and the second imaging apparatus, wherein the electronic processor is configured to generate a modified image, and a display for displaying the modified image of the material being moved by the work tool, wherein the modified image is based on a combination of the first image and the second image, and the modified image omits the work tool.

According to a second aspect of the present disclosure, a display system for a utility vehicle comprising a first imaging apparatus for capturing a first image of a first potion of a work tool of the utility vehicle, a second imaging apparatus for capturing a second image of a second portion of the work tool, an image generating unit in communication with the first imaging apparatus and the second imaging apparatus, wherein the image generating unit is configured to generate a modified image, where the modified image is based on a combination of the first image and the second image without showing the work tool, and a display unit for displaying the modified image.

According to a third aspect of the present disclosure, a method of operating a utility vehicle, the method comprising capturing a first image with a first imaging apparatus aimed at a first portion of a work tool, capturing a second image with a second imaging apparatus aimed at a second portion of the work tool, combining the first image with the second image to generate a third image, where the third image omits the work tool and includes an outline of the work tool, and displaying, on a display, the third image.

The above and other features will become apparent from the following description and accompanying drawings.

### BRIEF DESCRIPTION OF THE DRAWINGS

The detailed description of the drawings refers to the accompanying figures in which:

FIG. 1 is a side view of a utility vehicle with a blade, consistent with embodiments of the present disclosure;

FIG. 2 is a side view of the utility vehicle of FIG. 1 with a first imaging apparatus and a second imaging apparatus proximate a blade, consistent with embodiments of the present disclosure;

FIG. 3 is side view of a utility vehicle with the work tool of a utility vehicle moving material, consistent with embodiments of the present disclosure;

FIG. 4 is a front view of an image of the representation of material of FIG. 3 being moved with a see-through representation of the blade, consistent with embodiments of the present disclosure;

FIG. 5 is a representative view of a display, showing the third image with the material currently being moved by the blade without the blade in the image, consistent with embodiments of the present disclosure;

FIG. 6 is a schematic showing a blade control system for a utility vehicle, consistent with embodiments of the present disclosure; and

FIG. 7 is a flow diagram of a method for operating a utility vehicle, consistent with embodiments of the present disclosure.

Like reference numerals are used to indicate like elements throughout the several figures.

### DETAILED DESCRIPTION

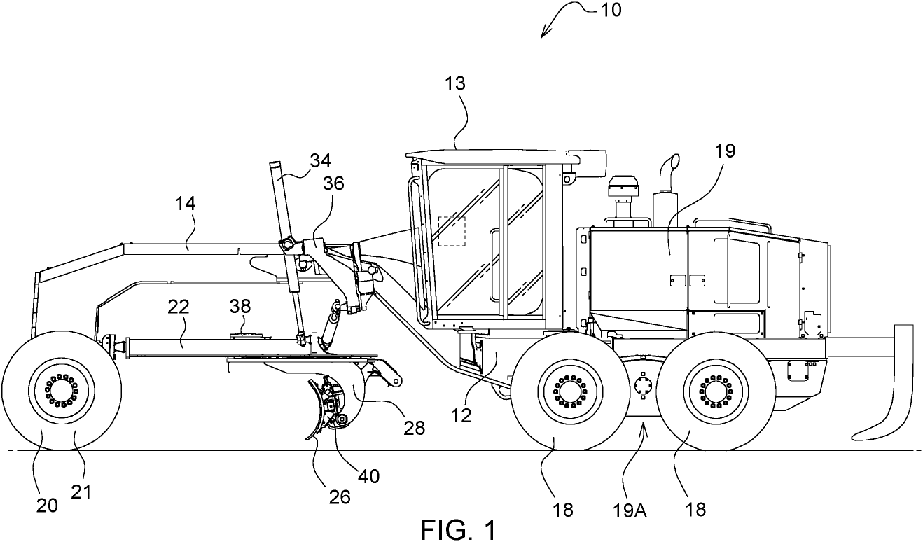

At least one example embodiment of the subject matter of this disclosure is understood by referring to FIGS. 1 through 7 of the drawings.

While the present disclosure has been illustrated and described in detail in the drawings and foregoing description, such illustration and description is not restrictive in character, it being understood that illustrative embodiment(s) have been shown and described and that all changes and modifications that come within the spirit of the present disclosure are desired to be protected. Alternative embodiments of the present disclosure may not include all of the features described yet still benefit from at least some of the advantages of such features. Those of ordinary skill in the art may devise their own implementations that incorporate one or more of the features of the present disclosure and fall within the spirit and scope of the appended claims.

While operating a utility vehicle, the position of the operator with respect to the work tool can make it difficult to see the amount of material being moved by the work tool at any given time. This can be challenging for a number of reasons. For example, when the operator wants to adjust for changes in terrain or other reasons, being able to see how much and/or how little material is accumulating in or on the work tool can be beneficial. With a limited view, the operator is slower to react to changes in conditions. Having an improved view of the material being moved by the blade could improve performance and accuracy of maneuvers being done by the utility vehicle. In embodiments described herein, using technology to allow the operator to “see through” or effectively eliminate a work tool would provide better information about processes being performed by the utility vehicle.

FIG. 1 is a side view of a utility vehicle with a blade, consistent with embodiments of the present disclosure. FIG. 1 illustrates a utility vehicle in the form of a motor grader 10. Although a utility vehicle is illustrated and described as the motor grader 10, the utility vehicle may include, for example, bulldozers, crawlers, feller bunchers, scrapers, excavators, skid and track loaders, or any other utility vehicle that uses a work tool (e.g., a bucket, a blade, a moldboard, etc.) to move material.

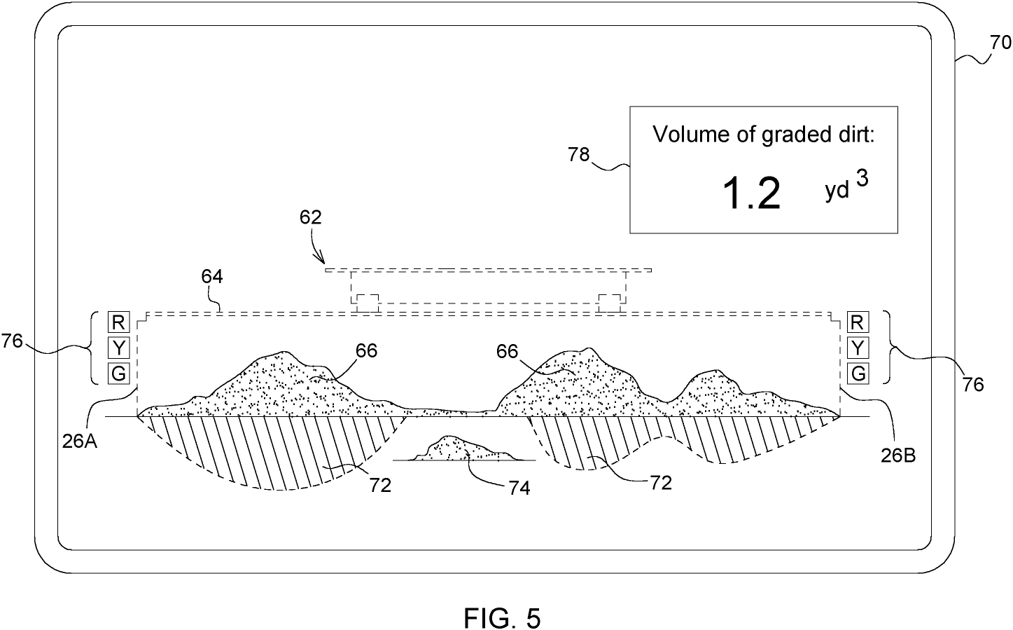

Motor grader 10 includes a main frame 12 and an articulated frame 14 which is pivotable with respect to main frame 12. Operator cab 13 is mounted atop articulated frame 14. Operator cab 13 includes operator controls, such as display unit 70 shown in FIG. 5 and described in detail below, such that a human operator can control the vehicle 10.

The articulated frame 14 includes a moldboard 26 (e.g., a blade) mounted thereto. The blade 26 is configured for spreading, leveling, or otherwise moving earthen or other material. In order to facilitate such operations, blade 26 is mounted to frame 14 such that blade 26 is selectively moveable in a number of directions. A draft frame 22 is coupled to articulated frame 14 toward the front via a ball-and-socket joint. A circle frame 28 is coupled to the draft frame 22 to rotate relative thereto by use of a circle drive 38 mounted to the draft frame 22. A tilt frame 40 holds the blade 26 and is coupled pivotally to the circle frame 28 for pivotal movement of the tilt frame 40 and the blade 26 held thereby relative to the circle frame 28 about a tilt axis by use of a tilt cylinder (not shown in FIG. 1).

The tilt cylinder is connected to circle frame 28 and tilt frame 40, such that actuation of tilt cylinder 30 changes the pitch of tilt frame 40 (and thus the moldboard 26) relative to circle frame 28. Left and right blade-lift cylinders 34 (i.e., hydraulic lift cylinders) are connected to saddle 36 (which in turn is fixed to articulation frame 14) and draft frame 22 such that actuation of left and right blade lift cylinders 34 raises and lowers the sides of draft frame 22, and thus the moldboard 26, relative to articulation frame 14

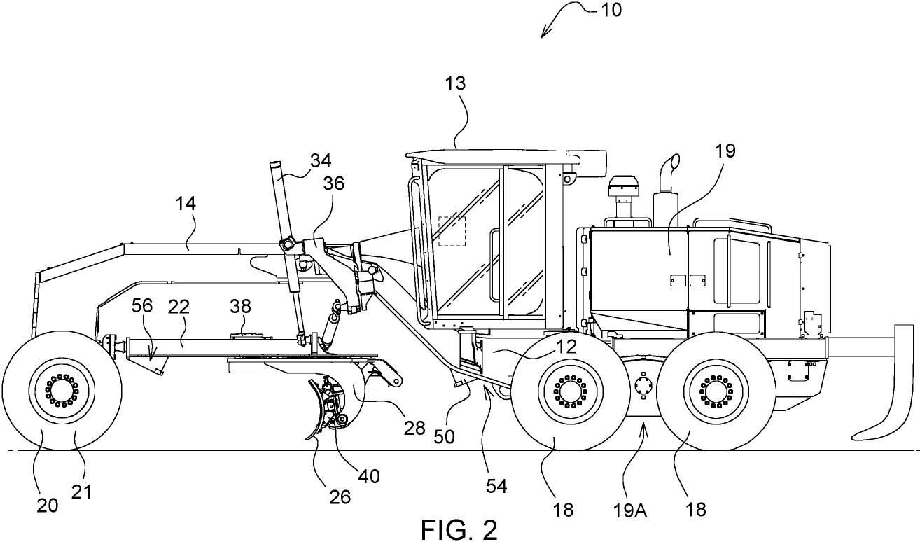

FIG. 2 is a side view of the utility vehicle of FIG. 1 with a first imaging apparatus and a second imaging apparatus proximate a blade, consistent with embodiments of the present disclosure. The utility vehicle 10 can include a first imaging apparatus 50 and a second imaging apparatus 52. The first imaging apparatus 50 can be coupled with, for example, the main frame 12 or other location (e.g., under the operator cab 13 or on the articulated frame 14) at a first position 54, where the first position 54 is rearward of the blade 26 (i.e., behind the blade 26; closer to the rear wheels 18). The position of the first imaging apparatus 50 can be any suitable location proximate the work tool (e.g., the first position 54 can be located in other locations beyond main frame 12). The main frame 12 can have a front end and a back end where the front end is proximate the front wheels 20, 21 and the back end can be proximate the rear wheels 18. The first imaging apparatus 50 can be positioned to view the back (i.e., the side closer to the rear wheels 18) of the blade 26. The second imaging apparatus 52 can be coupled with, for example, the draft frame 22 at a second position 56, where the second position is forward of the blade 26 (i.e., ahead of the blade 26; closer to the leanable front traction wheels 20, 21). The position of the second imaging apparatus 52 can be any suitable location proximate the work tool (e.g., the second position 56 can be located in other locations beyond draft frame 22). The second imaging apparatus 52 can be positioned to view the front (i.e., the side closer to the front wheels 20, 21) of the blade 26.

The first imaging apparatus 50 can capture a first image 58 and the second imaging apparatus 52 can capture a second image 60. For example, the first image 58 can show the back side (e.g., a first portion) of the blade, including any material coming off the left end of the blade 26 or the right end of the blade 26. The second image 60 can show the front of the blade 26 (e.g., a second portion), including the position and amount of material built up along the blade 26 and the upcoming grading surface (e.g., the surface of the terrain ahead of the blade that will come in contact with the blade soon). The upcoming terrain can include high points (e.g., mounds, piles, rises, etc.) and low points (e.g., holes, depressions, etc.).

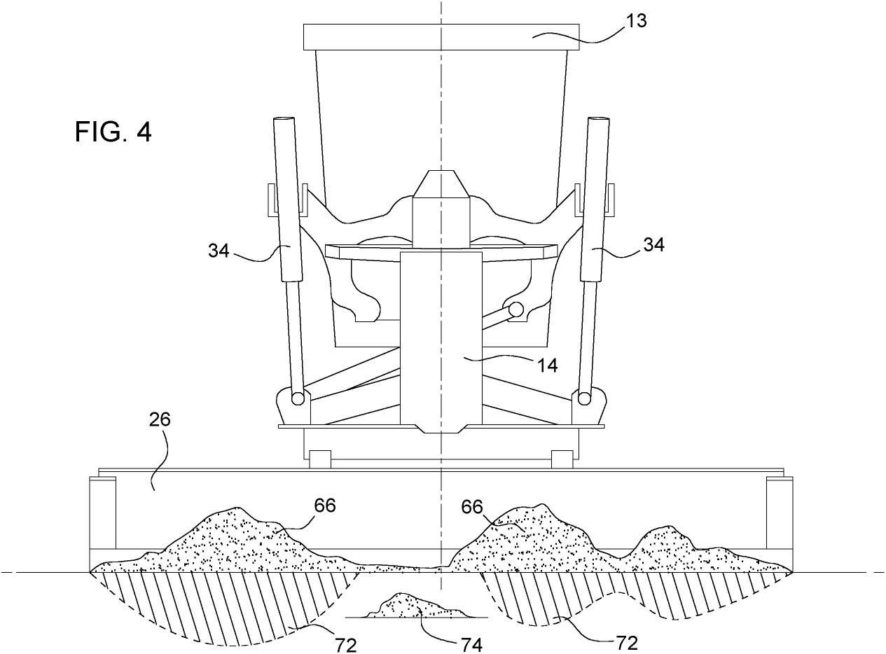

The first image 58 and the second image 60 can be used to generate a third image 62, where the third image 62 can be shown from the perspective of the first imaging apparatus (e.g., looking forward) or, alternatively, where the third image 62 can be shown from the perspective of the second imaging apparatus (e.g., looking rearward) where the third image 62 eliminates the blade 26 and shows the material being pushed by the blade 26 (e.g., as if the blade was invisible or “see through”; as if the blade was not there) and/or the upcoming terrain. See FIG. 4 and related discussion below for more information.

In some embodiments, a third imaging apparatus can be used to show the upcoming terrain. The third imaging apparatus could be located, for example, on the main frame 12 (or other location proximate the front area of the utility vehicle) and pointed forward towards the upcoming terrain when the utility vehicle is in forward motion.

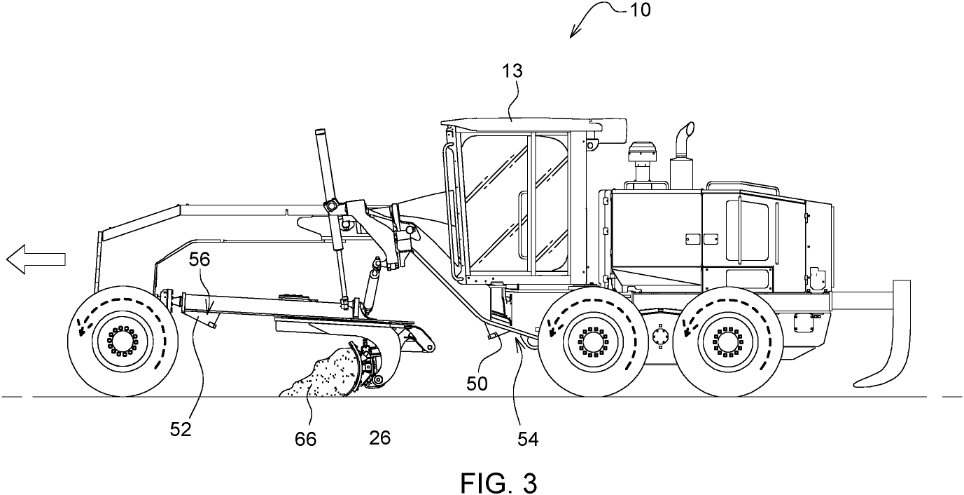

FIG. 3 is side view of a utility vehicle with the work tool of a utility vehicle moving material, consistent with embodiments of the present disclosure. As the utility vehicle 10 moves, the work tool 26 can be used to move material 66 (e.g., dirt, gravel, snow, ice, etc.). The amount of material 66 that is collected by the blade 26 can vary, depending on, for example, the type of material, the height of the work tool, the angle, pitch, and/or rotation of the work tool, the speed of the utility vehicle, size of work tool. Other outside factors could also affect the amount of material being collected by the blade including, for example, such as temperature, include of surface being graded, sun/no sun, etc.

Because of the position of the operator cab 13 with respect to the blade 26, the blade 26 itself, along with intervening portions of the utility vehicle 10 (e.g., the circle frame 28), can make it difficult and/or impossible to see amount of material being moved by the blade 26 at any given time. Having, for example, the first imaging apparatus 50 and the second imaging apparatus 52, along with the third image 62 can help the operator understand the amount of material 66 being moved by the blade 26 at any given time.

FIG. 4 is a front view of an image of the representation of material of FIG. 3 being moved with a see-through representation of the blade, consistent with embodiments of the present disclosure. As referenced above, the first image and the second image can be used to generate a third image, where the third image can be shown from the perspective of the second imaging apparatus (e.g., looking rearward) where the third image eliminates the blade 26 and shows the material being pushed by the blade 26. The blade 26 can be “invisible” or see-through by combining the first image and the second image to effectively eliminate the blade 26. A representation of the blade 26 can be included in the third image for reference. The representation can include an outline or translucent image of the blade 26.

The material being moved by the blade 26 (e.g., dirt, rock, snow, etc.) can accumulate in varying amounts at different locations along the blade 26. In this example, material 66 being moved by the blade 26 varies along the length of the blade 26. The amount of material 66 can vary and change over time as the utility vehicle 10 moves. As the amount of material 66 proximate the blade changes, the corresponding indication on the third image 62 can also change, which is viewable on the display 70 by an operator in the operator cab or remotely on a different monitor.

Also shown in FIG. 4 are areas of upcoming terrain. In this example, the upcoming terrain includes low points 72 and high points 74 (e.g., two examples of an upcoming terrain type) along the surface. As previously mentioned, the upcoming terrain can be identified by the second imaging apparatus or a third imaging apparatus.

Identification of the upcoming terrain can be determined by, for example, imaging apparatuses including stereo cameras, lidar, radar, or other similar devices. Identification of upcoming terrain can assist with identification of areas that require additional material (e.g., holes, low spots) which can be useful information for a grading operation.

FIG. 5 is a representative view of a display, showing the third image with the material currently being moved by the blade without the blade in the image, consistent with embodiments of the present disclosure. The display 70 can include the third image 62, which can include an outline 64 of the blade 26 and material 66 being moved by the blade 26.

The display 70 can show the material 66 being moved by the blade 26 and where the material 66 being moved is contacting the blade. The display 70 can also show the amount of the material 66 coming off an end 26A or 26B of the blade 26. This can be helpful for an operator as the terrain changes and the amount of material 66 being moved by the blade 26 changes.

For example, as the terrain drops away (i.e., dips down, drops, a hole, distance between the blade and the surface increases, etc.) the amount of material 66 moved by the blade 26 can decrease, resulting in less (or no) material 66 coming off an end of the blade 32.

Alternatively, as the terrain rises up (i.e., bumps up, a hump, a bump, a mound, a pile, distance between blade and the surface decreases, etc.) the amount of material 66 moved by the blade can increase, resulting is more material coming off an end 26A or 26B (or both ends) of the blade 26.

The display 70 can display information about the grading process. For example, blue shading (i.e., cross hatching pattern for low points 72) can demonstrate upcoming holes or depressions. Red shading (i.e., cross hatching pattern 2 for high points 74) can be the amount of material currently on the blade.

Additional color indicators 76 can be positioned on the display to represent the level of load currently being experienced by the work machine. For example, FIG. 5 shows color indicators 76 on either side of the blade 26. In this example, green (indicated by “G” in FIG. 5)) yellow (indicated by “Y” in FIG. 5) or red (indicated by “R” in FIG. 5) can cover a variety of work vehicle loads, with green indicating the level of load is OK, yellow indicating that caution should be used with that level of machine loading, and red to indicate when the load limit is being approached. The color indicators can be a first indicator of a load level on the work tool.

The display 70 can show the estimated volume 78 of material 66 that is being graded. See additional information and description below.

This information displayed on the monitor can give extra information to the operator regarding the amount of material on the blade. The operator can see how the amount of load on the blade and can see how the load is dispersed between the toe, heel, or middle of the blade.

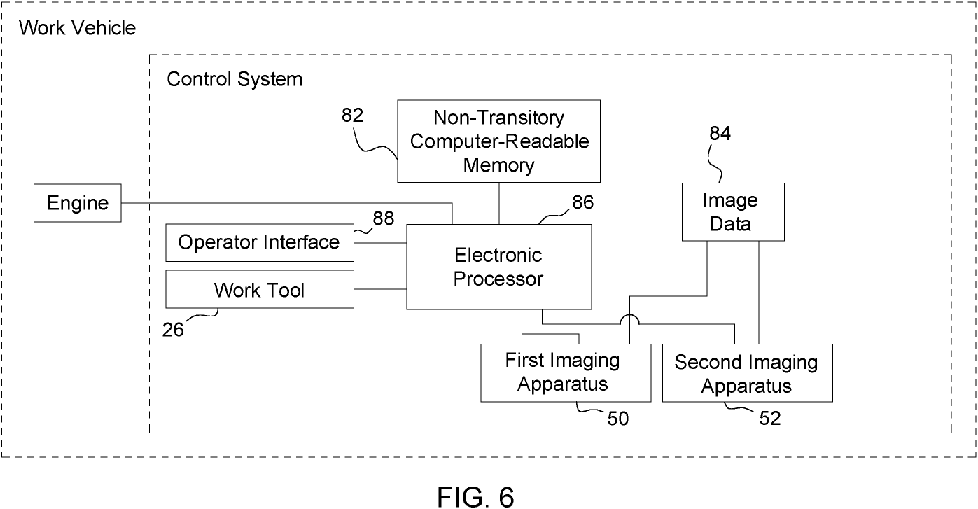

FIG. 6 is a schematic showing a blade control system for a utility vehicle, consistent with embodiments of the present disclosure. The blade control system 80 can include the first imaging apparatus 50 and the second imaging apparatus 52 coupled to the work vehicle 10. The first imaging apparatus 50 and the second imaging apparatus 52 are configured to capture a first image 58 and a second image 60 (i.e., image data) that includes the blade 26 as described above. The first imaging apparatus 50 and the second imaging apparatus 52 may each comprise a camera. The first imaging apparatus 50 and the second imaging apparatus 52 can be used to obtain images that are used to create a third image 62 (i.e., image data) that eliminates the work tool 26 in each image 58 and 60 from the first imaging apparatus 50 and the second imaging apparatus. The third image 62 may be displayed on the display 70 and the third image 62 may also include an outline of the work tool 26. The display 70 can also show the material 66 currently being moved by the blade 26 (i.e., work tool).

The blade control system 80 also has a non-transitory computer-readable memory 82 that stores image data 84. The non-transitory computer-readable memory 82 may comprise electronic memory, nonvolatile random-access memory, an optical storage device, a magnetic storage device, or another device for storing and accessing electronic data on any recordable, rewritable, or readable electronic, optical, or magnetic storage medium.

An electronic processor 86 (i.e., an image generating unit) is provided and configured to perform an operation by controllably adjusting a position of the work tool 26 relative to the utility vehicle 10 and capturing and processing images from the first imaging apparatus 50 and the second imaging apparatus 52 (and any additional imaging apparatuses). The electronic processor 86 may be arranged locally as part of the utility vehicle 10 or remotely at a remote processing center (not shown). In various embodiments, the electronic processor 86 may comprise a microprocessor, a microcontroller, a central processing unit, a programmable logic array, a programmable logic controller, or other suitable programmable circuitry that is adapted to perform data processing and/or system control operations. The electronic processor 86 executes or otherwise relies upon computer software applications, components, programs, objects, modules, or data structures, etc. Software routines resident in the included memory of the electronic processor 86 or other memory are executed in response to signals received.

The computer software applications, in other embodiments, may be located in the cloud. The executed software includes one or more specific applications, components, programs, objects, modules, or sequences of instructions typically referred to as “program code”. The program code includes one or more instructions located in memory and other storage devices which execute the instructions which are resident in memory, which are responsive to other instructions generated by the system, or which are provided by an operator interface 88 operated by the user (e.g., located in the operator cab or at a remote location). The electronic processor 86 is configured to execute the stored program instructions.

The electronic processor 86, along with the stored program instructions, can be used to estimate an amount of material being moved by the work tool. Based on the amount of area of an image of the blade that shows a material 66, the processor 86 can determine an estimate volume of material 66 being moved by the work tool.

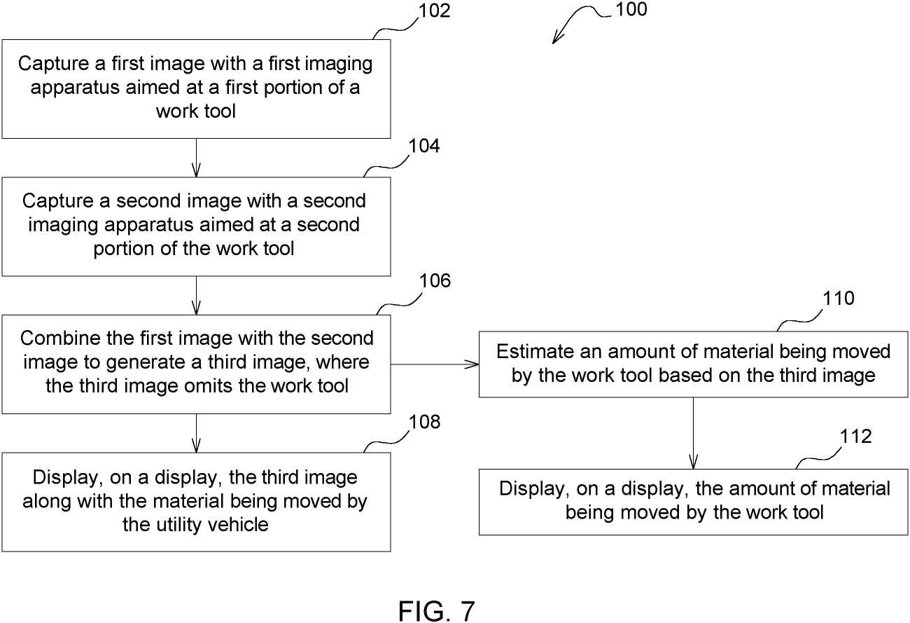

FIG. 7 is a flow diagram of a method for operating a utility vehicle, consistent with embodiments of the present disclosure. The method 100 for showing material being moved by a utility vehicle can include the step 102 of capturing a first image with a first imaging apparatus aimed at a first portion of a work tool, the step 104 of capturing a second image with a second imaging apparatus aimed at a second portion of the work tool, the step 106 of combining the first image with the second image to generate a third image, where the third image omits the work tool; and the step 108 of displaying, on a display, the third image along with the material 66 being moved by the utility vehicle.

The method 100 can further comprise the step 110 of estimating the volume of material being moved by the work tool base. Based on analysis of the third image, an estimate for the volume of material being moved by the work tool can be determined. This estimate is based on a comparison of the amount of the image that shows material being moved compared to the area of the work tool. The estimated amount of material can be based on, for example, the amount of material on (i.e., against, touching, being moved by) the blade (i.e., work tool) and the size of the blade (i.e., work tool). By having the size and area of blade determined, a volumetric area of interest can be set. When an imaging device (e.g., a camera) can see and determine how much of the volumetric area is covered by material, an estimate of the amount of material being moved can be made.

The method 100 can further comprise the step 112 of displaying, on a display, the amount of material being moved by the work tool.

What is claimed is:

1. A utility vehicle comprising:
a main frame;
a work tool configured to move relative to the main frame to move a material;
a first imaging apparatus aimed at a first portion of the work tool to capture a first image;
a second imaging apparatus aimed at a second portion of the work tool to capture a second image;
an electronic processor in communication with the first imaging apparatus and the second imaging apparatus, wherein the electronic processor is configured to generate a modified image; and
a display for displaying the modified image of the material being moved by the work tool, wherein the modified image is based on a combination of the first image and the second image, and the modified image omits the work tool.

2. The utility vehicle of claim 1, wherein the work tool comprises a blade coupled with the utility vehicle.

3. The utility vehicle of claim 2, wherein the first portion of the work tool is a back side of the blade and the second portion of the work tool is a front side of the blade.

4. The utility vehicle of claim 1, further comprising an operator cab supported by the main frame, wherein the work tool is positioned longitudinally forward of the operator cab.

5. The utility vehicle of claim 1, wherein the work tool includes at least one of a blade, a bucket, a scraper, and a box blade.

6. The utility vehicle of claim 1, wherein the first imaging apparatus and the second imaging apparatus are attached to the main frame.

7. The utility vehicle of claim 1, wherein the first imaging apparatus and the second imaging apparatus are attached to the work tool.

8. The utility vehicle of claim 1, wherein the first imaging apparatus faces a rear end of the main frame and the second imaging apparatus faces a front end of the main frame.

9. The utility vehicle of claim 1, wherein the modified image includes one or more of an outline of the work tool.

10. A display system for a utility vehicle comprising:
a first imaging apparatus for capturing a first image of a first potion of a work tool of the utility vehicle;
a second imaging apparatus for capturing a second image of a second portion of the work tool;
an image generating unit in communication with the first imaging apparatus and the second imaging apparatus, wherein the image generating unit is configured to generate a modified image, where the modified image is based on a combination of the first image and the second image without showing the work tool; and
a display unit for displaying the modified image.

11. The display system of claim 10, wherein the modified image comprises one or more of a first indicator of load level on the utility vehicle, a second indicator of upcoming terrain type, and an estimated volume of material on the work tool.

12. The display system of claim 10, wherein the first portion of the work tool is a back side of a blade and the second portion of the work tool is a front side of the blade.

13. The display system of claim 10, the utility vehicle further comprising:
a main frame;
an operator cab supported by the main frame;
wherein the work tool is positioned longitudinally forward of the operator cab.

14. The display system of claim 10, wherein the first imaging apparatus is coupled with the main frame and the second imaging apparatus is coupled with a draft frame.

15. The display system of claim 10, wherein the first imaging apparatus and the second imaging apparatus are coupled with locations proximate the work tool.

16. The display system of claim 10, wherein the first imaging apparatus faces a rear end of the utility vehicle and the second imaging apparatus faces a front end of the utility vehicle.

17. The display system of claim 10, wherein the first imaging apparatus and the second imaging apparatus each comprise a camera.

18. The display system of claim 10, wherein the modified image includes an outline of the work tool.

19. A method of operating a utility vehicle, the method comprising:
capturing a first image with a first imaging apparatus aimed at a first portion of a work tool;
capturing a second image with a second imaging apparatus aimed at a second portion of the work tool;
combining the first image with the second image to generate a third image, where the third image omits the work tool and includes an outline of the work tool; and
displaying, on a display, the third image.

20. The method of claim 19, wherein the third image comprises one or more of a first indicator of load level on the utility vehicle, a second indicator of upcoming terrain type, and an estimated volume of material on the work tool.
